(19) United States
(12) Patent Application Publication
(10) Pub. No.: US 2010/0299123 A1
(43) Pub. Date: Nov. 25, 2010

(54) WELL PLACEMENT IN A VOLUME

(75) Inventors: HAYTHEM OUNAISSA, Abingdon (GB); TRULS SKAARE, Abingdon (GB); PETER WARDELL-YERBURGH, Abingdon (GB)

Correspondence Address: SCHLUMBERGER INFORMATION SOLUTIONS, 5599 SAN FELIPE, SUITE 1700, HOUSTON, TX, 77056-2722, US

(73) Assignee: SCHLUMBERGER TECHNOLOGY CORPORATION, Sugar Land, TX (US)

(21) Appl. No.: 12/469,844

(22) Filed: May 21, 2009

(51) Int. Cl. G06G 7/48

(52) U.S. Cl. 703/10

(57) ABSTRACT

Implementations of well placement in a volume are described. Some techniques described herein involve ascertaining a skeleton of a volume within a reservoir, and using the skeleton to map out a well topology to retrieve resources, such as hydrocarbons, from the volume. In one possible implementation, the skeleton can be found by generating a repulsive field throughout an interior of the volume, with the field decreasing with distance from the boundary of the volume. Interior points where a magnitude of the force drops to within a preset value are called critical points. The skeleton can be found by following outward flow from the volume from critical point to critical point.

### BACKGROUND

When developing an oil or gas field, production wells are drilled to allow hydrocarbons to flow to the surface. In some instances oil, gas and water can be produced through the wells simultaneously. To maintain pressure or increase recovery of oil and gas, injector wells can be drilled and production wells can be converted to injector wells.

Well placement configurations can be evaluated before a field is developed, and production wells can be designed and drilled to reach un-swept hydrocarbon deposits as the field is produced. Production wells can have one or more laterals, thereby increasing production by contacting more of the reservoir than a simple vertical well.

### SUMMARY

Implementations of well placement in a volume are described. In one possible embodiment, a volume defined by a boundary within a reservoir is obtained and a skeleton for the volume is determined. The skeleton is then used to ascertain a well topology for the volume.

This summary is provided to introduce a selection of concepts that are further described below in the detailed description. This summary is not intended to identify key features or essential features of the claimed subject matter, nor is it intended to be used as an aid in determining the scope of the claimed subject matter.

### BRIEF DESCRIPTION OF THE CONTENTS

The detailed description is described with reference to the accompanying figures. In the figures, the left-most digit of a reference number identifies the figure in which the reference number first appears. The use of the same reference numbers in different figures indicates similar or identical items.

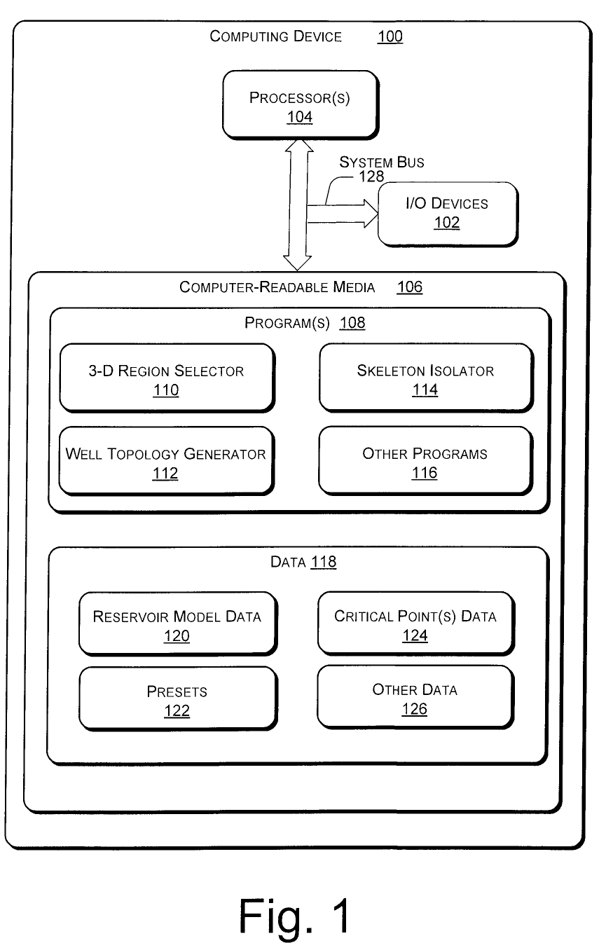

FIG. 1 illustrates an example computing device on which elements of well placement in a volume may be implemented.

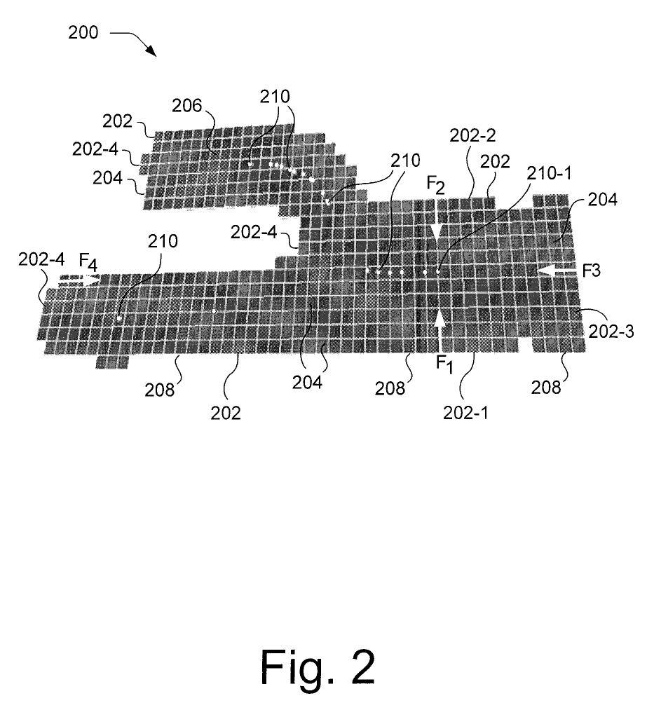

FIG. 2 illustrates critical points in a volume within a reservoir in accordance with one embodiment of well placement in a volume.

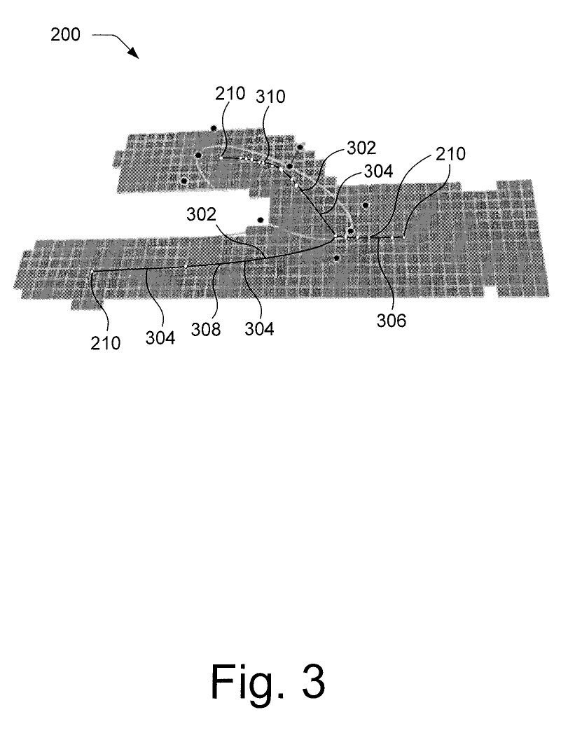

FIG. 3 illustrates an example of grouped critical points forming a skeleton in accordance with another embodiment of well placement in a volume.

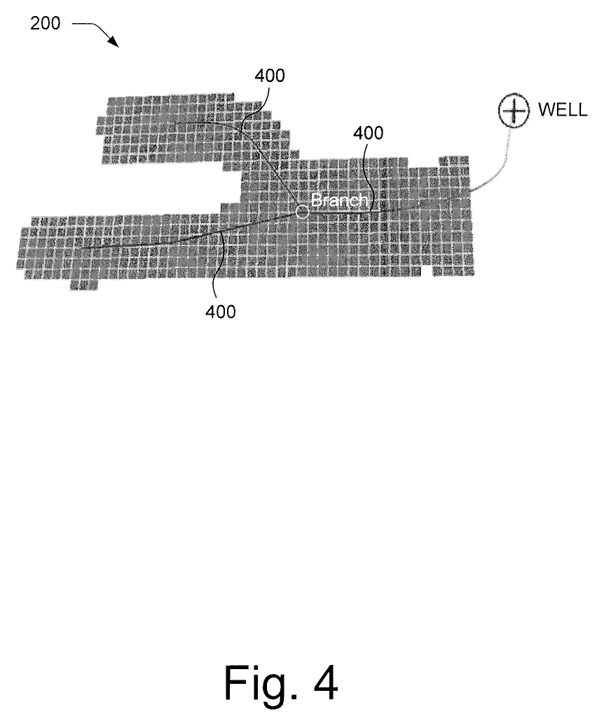

FIG. 4 illustrates an example well topology for a volume within a reservoir in accordance with yet another embodiment of well placement in a volume.

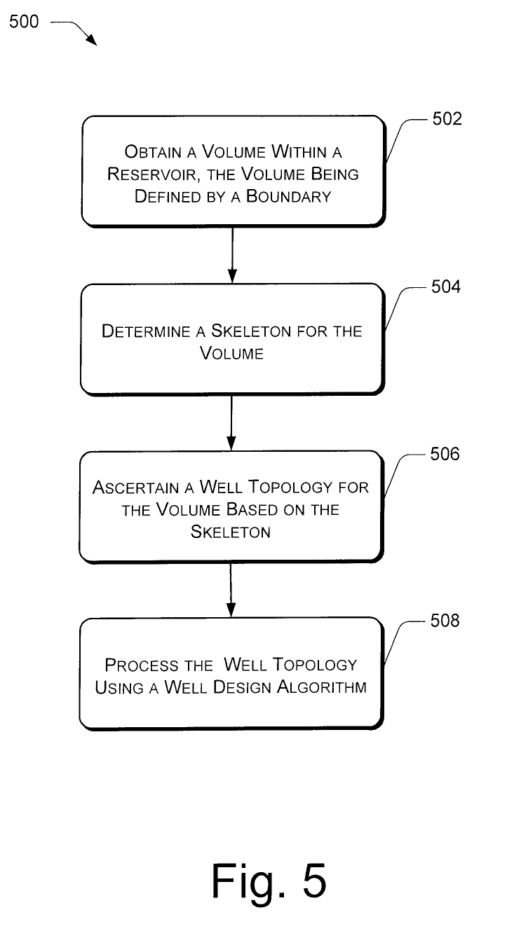

FIG. 5 illustrates example method(s) for well placement in a volume.

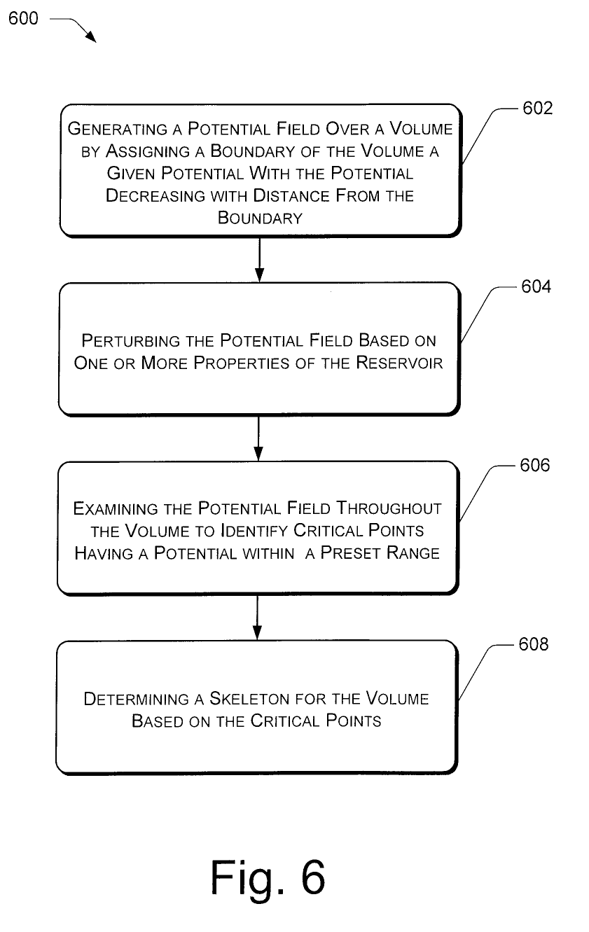

FIG. 6 illustrates example method(s) for well placement in a volume.

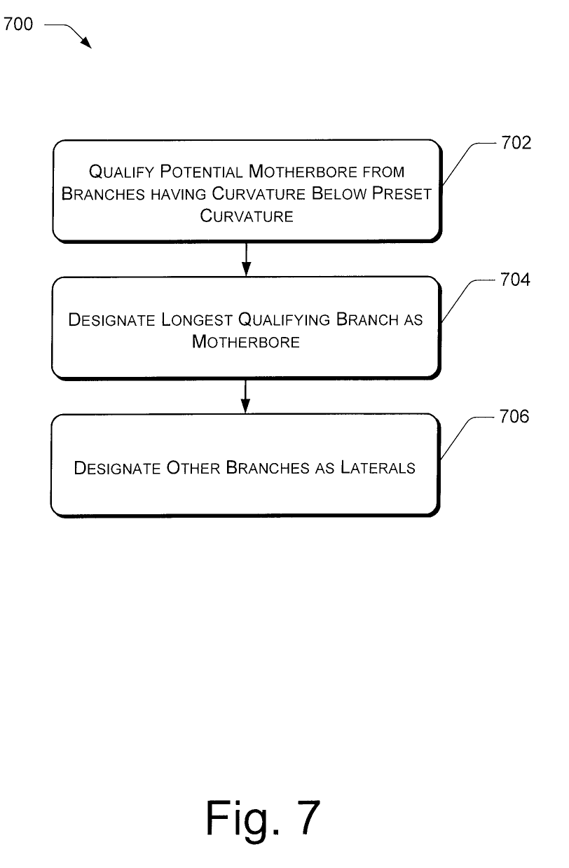

FIG. 7 illustrates example method(s) for well placement in a volume.

### DETAILED DESCRIPTION

This disclosure is directed to techniques for implementing well placement in a volume. More particularly, the techniques described herein involve ascertaining a skeleton of a volume within a reservoir, and using the skeleton to map out a well topology to retrieve resources, such as hydrocarbons, from the volume.

For example, once a volume with a specified level of resources has been located within a reservoir, a skeleton of the volume can be isolated. The skeleton can take many forms. For example, in one possible implementation the skeleton can be a line defined by points throughout the volume, wherein each point is located at a furthest distance from a boundary of the volume.

In another possible implementation, the skeleton can be found by generating a repulsive field throughout an interior of the volume, with the field decreasing with distance from the boundary of the volume. Interior points where a magnitude of the force drops to within a preset value are called critical points. The skeleton can be found by following outward flow from the volume from critical point to critical point.

Once determined, the skeleton can be used to develop a well topology for the volume. For example, in one possible embodiment, if the skeleton has two or more branches, a motherbore can be isolated as a branch having a smallest curvature. Branches aside from the motherbore can be modeled as lateral wells.

### Example Environment

FIG. 1 shows an example computing device 100 suitable for implementing embodiments of well placement in a volume. Computing device 100 can be implemented as any form of computing and/or electronic device. For example, computing device 100 can include a server, a desktop PC, a notebook or portable computer, a workstation, a mainframe computer, an Internet appliance and so on. Computing device 100 includes input/output (I/O) devices 102, one or more processor(s) 104, and computer readable media 106.

I/O devices 102 can include any device over which data and/or instructions can be transmitted or received by computing device 100. For example, I/O devices 102 can include one or more of an optical disk drive, a USB device, a keyboard, a touch screen, a monitor, a mouse, a digitizer, a scanner, a track ball, etc.

I/O devices 102 can also include one or more communication interface(s) implemented as any of one or more of a serial and/or parallel interface, a wireless interface, any type of network interface, a modem, a network interface card, or any other type of communication interface capable of connecting computing device 100 to a network or to another computing or electrical device.

Processor(s) 104 include microprocessors, controllers, and the like configured to process various computer executable instructions controlling the operation of computing device 100. For example, processor(s) 104 can enable computing device 100 to communicate with other electronic and computing devices, and to process instructions and data in conjunction with programs 108 stored in computer-readable media 106.

Computer-readable media 106, can include one or more memory components including random access memory (RAM), non-volatile memory (e.g., any of one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 106 provides storage mechanisms to store various information and/or data such as software applications and any other types of information and data related to operational aspects of computing device 100. For example, programs 108 stored on computer-readable media 106 can include a 3-D region selector 110, a well topology generator 112, a skeleton isolator 114 and other programs 116—such as an operating system and/or assorted application programs. Programs 108 can be executed on processor(s) 104.

Computer-readable media 106 can also include data 118. For example, as illustrated in FIG. 1, data 118 residing on computer-readable media 106 can include reservoir model data 120, presets 122, critical point(s) data 124, and other data 126 (including intermediate and final data created through use of one or more of programs 108).

Any of programs 108 and data 118 can reside wholly or partially on any of a variety of media types found in computer-readable media 106. For example portions of skeleton isolator 114 can reside at different times in random access memory (RAM), read only memory (ROM), optical storage discs (such as CDs and DVDs), floppy disks, optical devices, flash devices, etc.

A system bus 128 can couple one or more of the processor(s) 104, I/O devices 102 and computer-readable media 106 to each other. System bus 128 can include one or more of any of several types of bus structures, including a memory bus or memory controller, a peripheral bus, an accelerated graphics port, and a processor or local bus using any of a variety of bus architectures. By way of example, such architectures can include an industry standard architecture (ISA) bus, a micro channel architecture (MCA) bus, an enhanced ISA (EISA) bus, a video electronics standards association (VESA) local bus, and a peripheral component interconnects (PCI) bus also known as a mezzanine bus, and so on.

### Example Volume

FIG. 2 illustrates a volume 200 with which embodiments of well placement in a volume can be practiced. Volume 200 is encompassed by a boundary 202, and can include any 3 dimensional region within a reservoir such as an oilfield.

For instance, a user may isolate volume 200 by reviewing reservoir model data 120 of a given reservoir. It will be understood that reservoir model data 120 can include geological data regarding the given reservoir found using nonintrusive techniques (i.e. seismic, electronic or pneumatic test results) and/or intrusive techniques, including well logs and assorted pressure, temperature and other information found using various tools and instrumentation, including instrumentation lowered into one or more wells or other openings in or near the reservoir.

In one implementation, reservoir model data 120 can be raw, unprocessed data. In another implementation, reservoir model data 120 can include a reservoir model created from data processed and configured through use of reservoir engineering software and/or modeling techniques known in the art.

A user can access reservoir model data 120 including a digital model of the reservoir broken into individual spaces 204, such as voxels. In one implementation, all spaces 204 in volume 200 have a uniform volume. In another implementation, spaces 204 in volume 200 can have differing volumes.

The user can query for a collection of spaces 204 representing a region of desired potential. In one implementation, such a query can be handled by specialized software, such as 3-D region selector 110. Preset values for desired potentials can be stored in presets 122.

For example, the user can query for all spaces 204 having a hydrocarbon potential above a preset value (such as 50% oil saturation, etc). Alternately, the user can query for a region throughout which the average hydrocarbon potential is above a preset value. In such a query some spaces 204 within the returned volume 200 can have a potential below the preset value, but might likely be near spaces 204 having potentials over the preset value, such that a connected volume of points is isolated.

Once volume 200 is isolated, a well topology for volume 200 can be estimated by isolating a skeleton for volume 200. Several different skeletons can exist for volume 200, with each skeleton representing a different path in volume 200 through which resources can efficiently be recovered.

In one possible implementation, a skeleton for volume 200 can be seen as a line representing a volumetric centroid within the various branches 206, 208 of volume 200. In another possible implementation, the skeleton of volume 200 can be a line running through points in volume 200 which are located at a distance furthest from boundary 202 of volume 200. In one implementation, these points can be called critical points.

The skeleton for volume 200 can be found using several different techniques known in the art including, but not limited to, computing hierarchical curve-skeletons of three dimensional objects. For instance, critical points 210 within volume 200 can be found by simulating a directional force field through an interior of volume 200. This directional force field can be given a local maximum value at boundary 202 and decrease with distance there from. For example, in one implementation, a simulated directional force at boundary 202 can be propagated into spaces 204 in volume 200 using a distance weighted approach. The directional force field can be simulated using any forces known in the art, including electrical forces, magnetic forces, etc.

For purposes of illustration and not limitation, a force F1 perpendicular to boundary 202-1 and oriented towards an interior of volume 200 can be assigned. Similarly, a force F2 perpendicular to boundary 202-2 and oriented towards the interior of volume 200 can be assigned. Similarly, forces F3 and F4 at boundaries 202-3 and 202-4 respectively can be assigned.

A sum of the forces F1, F2, F3 and F4 can be calculated for spaces 204 within volume 200, to arrive at a critical point 210-1 where the resulting force field created by F1, F2, F3 and F4 on a space 204 is within a preset range. In one implementation, this preset range can be set at or near zero.

Similar calculations can be conducted to locate various critical points within volume 200 by applying forces along selected points throughout a length of boundary 202-1, a length of boundary 202-2, a length of boundary 202-3 and a length of boundary 202-4. Alternately, in another possible implementation, the forces can be applied as a uniform force field along the entire lengths of boundaries 202-1, 202-2, 202-3, 202-4.

Volume 200 has been represented in two dimensions for the sake of graphic clarity. However, it will be understood that boundary 202 encompasses volume 200 in three dimensions. Therefore, the forces assigned to boundary 202 in the manner described above need not only be applied along the lengths of boundaries 202-1, 202-2, 202-3, 202-4 but rather the forces can be applied normal to boundary 202 as boundary 202 describes volume 200, thus creating a three dimensional force field within volume 200. Points in volume 200 subjected to three dimensional forces within a given range can be identified as critical points 210.

In one implementation, three dimensional force calculations can be conducted by applying a uniform force field along an entire surface area of boundary 202. Similarly, discrete forces can be applied at predetermined points along the surface area of boundary 202. For example, forces can be applied in grid or other patterns.

Moreover critical points 210 can be seen as occupying entire spaces 204 with which they are associated. Alternately, critical points 210 can be seen as occupying subsets of one more spaces 204 (i.e. a particular position within a space 204, such as a midpoint, a position between two spaces 204, and so on).

Volume 200 can also be influenced by perturbation. For instance, regions associated with volume 200 (including regions partially or fully outside of volume 200) can be assigned various importances and/or weights. Regions of this type can include any sort of reservoir and or geological properties, including faults, geological horizons, water-oil and/or gas-oil contacts, and so on.

For example, if a geologic feature found in volume 200 is preferably avoided (such as a deposit of very hard minerals, or a deposit with potentially troubling amounts of water) spaces 204 in and/or around the region can be weighted to perturb critical points 210 (and thus any resulting skeleton(s) of volume 200) away from the region. Alternately, if a region inside volume 200 has one or more attractive qualities, such as a high resource potential (i.e. a region of high oil in place (OIP)), spaces 204 in the region can be weighted to perturb critical points 210 towards the region.

Returning to the force field example above, in one implementation, perturbation can be accomplished by weighting regions of interest with their own force fields. For instance, if a region of high OIP is located in volume 200, spaces 204 in the region may be assigned an extra level of force field to be summed with the force field originating at boundary 202. The additional perturbing forces can be set such that critical points 210 in volume 200 are biased to approach spaces 204 having attractive potentials and depart from (or be deflected away from) spaces 204 having unwanted potentials.

As noted above, numerous approaches can be used to locate critical points 210 in volume 200. These include approaches in which volume 200 is perturbed and approaches in which volume 200 is not perturbed. Regardless of what approach is used, varying numbers of critical points 210 can be located in volume 200, with the number of critical points 210 being isolated often depending on accuracy desired and computing power and resources available. In one implementation, locations and other data associated with critical points 210 can be saved in critical point(s) data 124.

### Example Skeleton

FIG. 3 illustrates volume 200 in which a plurality of critical points 210 have been isolated to determine a skeleton 302. In one implementation, skeleton 302 can include a path leading through areas of interest in volume 200. For example, if volume 200 includes hydrocarbons, such as gas and/or oil, skeleton 302 can include a path of flow of hydrocarbons out of volume 200. Critical points 210 can include all or a subset of critical points 210 which have been found in volume 200. Isolation of skeleton 302 as well as isolation of critical points 210 can be accomplished with assistance of skeleton isolator 114.

In one possible embodiment, skeleton 302 can be constructed from critical points 210 using any spanning tree algorithm known in the art. For instance, critical points 210 in volume 200 can be connected in a variety of possible configurations with weights being attached to segments 304 between critical points 210. In one possible implementation, weights can be assigned to segments 304 based on favorability of each segment 304. Weights of each segment 304 making up a tree representing skeleton 302 can then be summed to arrive at a total value for skeleton 302. In this way the sums of varying iterations of trees can be compared against one another, and skeleton 302 can be chosen from among one or more trees having a favorable sum.

Weights of segments 304 can depend on a variety of factors, including segment length (i.e. distance between critical points 210 defining a segment 304), angle from contiguous segments 304, etc.

In one possible implementation, an undirected graph can be created by considering critical points 210 as vertices. Two critical points 210 can be considered connectible if an angle between (1) a potential field, such as a three dimensional force field discussed above in conjunction with FIG. 2, at one of the critical points 210 and (2) a segment 304 connecting the critical points 210 is within a given value. If the critical points 210 are determined to be connectible, the resulting segment 304 can be assigned a weight based on the length of the segment. In one aspect, this can be done using, for example, a Euclidean distance of the segment 304.

In this manner, all of critical points 210 can be traversed and connected with segments 304 to arrive at a spanning tree. In some possible implementations, several different spanning trees can be created from critical points 210 in volume 200. As noted above, the various spanning trees can be evaluated by summing the weights of the segments 304 making up each spanning tree. In one implementation, a spanning tree having a favorable sum can be chosen to be used for skeleton 302. For example, a spanning tree connecting all of critical points 210 with a least amount of Euclidean distance may be seen as having a favorable sum.

Once skeleton 302 is isolated, it is viewed for an existence of multiple branches. In some cases, there will be only one branch. In such an instance, the single branch will be the motherbore.

In other cases, skeleton 302 will include two or more branches, such as branches 306, 308 and 310 illustrated in FIG. 3. In one implementation, branches 306, 308, 310 can be viewed to determine if a branch exists having a favorable curvature. For example, curvature between branches 306 and 308 appears to be less than curvature between branches 306 and 310. Therefore, branches 306 and 308 can be termed as the motherbore, while branch 310 can be termed as a lateral from the motherbore.

In one implementation, if branches 306 and 308 have a similar curvature to branches 306 and 310, other qualities such as length can be used to determine the motherbore and laterals (i.e. the longer of branches 306, 308 and 306, 310 can be seen as the motherbore). Similar logic can be extended to trees having any number of branches to arrive at a motherbore and any number of laterals from the motherbore.

### Example Well Design

FIG. 4 illustrates volume 200 in which skeleton 302 has been used to arrive at a well design 400. A user can base well design 400 entirely on a position of skeleton 302. Alternately, a user can process some or all of the information associated with skeleton 302 to arrive at well design 400. In one implementation, this can include processing some or all of the information associated with skeleton 302 using one or more well design algorithms to join points within volume 200 while honoring various drilling constraints such as dog leg severity (DLS). A user can also process information from skeleton 302 and or well design 400 in other ways. For example, well design 400 can be manipulated in space to fulfill drilling objectives. This can include moving well design 400 relative to a surface of the reservoir in order to avoid obstacles (such as, for example, a water). Well design 400 can also be shifted other directions in space or tilted as needed to fulfill drilling objectives and/or avoid potential drilling problems. In one implementation, all or part of creating and/or altering well design 400 can be accomplished through use of well topology generator 112.

### Exemplary Methods

FIGS. 5-7 illustrate example methods for implementing aspects of well placement in a volume. The methods are illustrated as a collection of blocks in a logical flow graph representing a sequence of operations that can be implemented in hardware, software, firmware, various logic or any combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described therein. In the context of software, the blocks can represent computer instructions that, when executed by one or more processors, perform the recited operations. Moreover, for discussion purposes, and not purposes of limitation, selected aspects of the methods may be described with reference to elements shown in FIGS. 1-4.

### Example Method I

FIG. 5 illustrates an example method 500 for implementing well placement in a volume. At block 502, a volume defined by a boundary within a reservoir is obtained. In one implementation, this can include volume 200 and boundary 202.

In one embodiment, this can be done by accessing reservoir model data, such as reservoir model data 120, including a digital model of the reservoir broken into individual spaces, such as spaces 204.

The user can query for a collection of spaces representing a region of desired potential, such as spaces all having a potential over a preset value, or spaces throughout which the average potential is above a preset value (in such a query some spaces within the returned region could have a potential below the preset value, but might likely be near spaces having potentials over the preset value, such that a connected volume of points could be isolated).

At block 504 a skeleton, such as skeleton 302, for the volume is determined. In one implementation, the skeleton is found by locating a volumetric centroid throughout branches of the volume. In another implementation the skeleton is found by locating and connecting points that are a maximum distance away from the boundary of the volume at various points throughout the volume.

In still another implementation the skeleton is found by locating critical points, such as critical points 210, in the volume and connecting the critical points with segments such as segments 304. For example, critical points can be found by simulating a force field throughout the volume, with the force field having a maximum value at the boundary of the volume and decreasing with distance therefrom. The simulated force field can also be perturbed by assigning force field values to areas of interest associated with the volume. For example, areas of especially high resource potential can be assigned a high filed value to perturb critical points towards them.

Critical points can be identified by summing the force field values on individual spaces in the region and identifying spaces with field values within a given range. In one implementation, this range can be at or near zero.

Once located, possible variations of connections of the critical points can be viewed to see if one or more variations include a shorter or more efficient flow path through the volume. For example, the critical points can be connected using one or more spanning tree algorithms such as those described above in conjunction with FIGS. 2-3.

If the skeleton includes two or more branches, such as branches 306, 308 and 310, the branches can be viewed to determine if one branch exists having a lesser curvature. Such a branch can be seen as a motherbore, while the other branches can be seen as laterals. If the branches have a similar curvature, other qualities such as length can be used to determine the motherbore and laterals (for example, with the longer branch being seen as the motherbore).

At block 506, a well topology such as well design 400, can be based wholly or in part on the skeleton.

At block 508, the well topology can be processed using a well design algorithm. This can involve processing some or all of the information associated with skeleton using one or more well design algorithms to join points within the volume while honoring various drilling constraints. In one implementation, the well topology can be manipulated in space to fulfill drilling objectives.

### Example Method II

FIG. 6 illustrates an example process 600 for determining a skeleton for a volume in accordance with one implementation of well placement in a volume

At block 602 a potential field is generated over a volume of interest by assigning a boundary defining the volume a given potential decreasing with distance from the boundary. In one implementation, the volume is a region such as volume 200 and the boundary is similar to boundary 202.

This can be done using several different techniques known in the art including, but not limited to, computing hierarchical curve-skeletons of three dimensional objects. For example, in one implementation, a simulated directional force at the boundary can be propagated into spaces, such as spaces 204, in the volume using a distance weighted approach. The directional force field can be simulated using any forces known in the art, including electrical forces, magnetic forces, etc.

In one implementation, three dimensional force calculations can be conducted by applying a uniform force field along an entire surface area of the boundary. In another implementation, forces can be applied to the surface of the boundary in a pattern, such as along a grid or other configuration.

At block 604 the potential field is perturbed based on one or more properties of the reservoir. For instance, regions associated with the volume (including regions partially of fully outside of the volume) can be assigned various importances and/or weights. Regions of this type can include any sort of reservoir and/or geological properties, including faults, geological horizons, water-oil and/or gas-oil contacts, and so on.

For example, if a geologic feature found in the volume is preferably avoided (such as a deposit of very hard minerals, or a deposit with potentially troubling amounts of water) spaces in and/or around the region can be weighted to perturb critical points away from the region. Alternately, if a region inside the volume has one or more attractive qualities, such as a high resource potential (i.e. a region of high oil in place (OIP)), spaces in the region can be weighted to perturb critical points towards the region.

In one implementation, perturbation can be accomplished by weighting regions of interest with their own force fields. For instance, if a region of high OIP is located in the volume, spaces in the region may be assigned an extra level of force field to contravene the force field existing in the spaces of the volume from the forces simulated at the boundaries. In such a manner the extra level of force field can be used to reduce the existing force field at points in the region of interest so that a sum of forces goes to at or near zero in the area of interest.

The additional perturbing forces can be set such that critical points in the volume are biased to approach spaces having attractive potentials and depart from (or be deflected away from) spaces having unwanted potentials. In one implementation, perturbation can include assigning no additional perturbation forces when no regions of interest are found in the volume.

At block 606 the potential field throughout the volume is examined to identify critical points having a potential within a reset range. In one implementation, a resultant force from the force at the boundary and any regional forces due to perturbation are calculated at one ore more spaces within the volume. Spaces where the results of the various forces are within a preset range can be seen as having a critical point. In one implementation, this preset range can be set at or near zero.

Critical points can be seen as occupying entire spaces with which they are associated. Alternately, critical spaces can be seen as occupying subsets of one more spaces (i.e. a particular position within a space, such as a midpoint, a position between two spaces, and so on).

At block 608 a skeleton for the volume is determined based on the critical points. In one possible embodiment, the skeleton can be skeleton 302.

The skeleton can be constructed from critical points using any spanning tree algorithm known in the art. For instance, critical points in the volume can be connected in a variety of possible configurations with weights being attached to segments between critical points, such as segments 304 between critical points 210. In one possible implementation, weights can be assigned to the segments based on a favorability of each segment. Weights of each segment making up a tree representing the skeleton can then be summed to arrive at a total value for each skeleton. In this way the sums of various iterations of trees can be compared against one another, and a skeleton can be chosen as a tree having a favorable sum.

Weights of the segments can depend on a variety of factors, including segment length (i.e. distance between critical points defining a segment), angle from contiguous segments, etc.

In one possible implementation, an undirected graph can be created by considering critical points as vertices. Two critical points can be considered connectible if an angle between (1) a potential field, such as a three dimensional force field discussed above at blocks 602-604, at one of the critical points and (2) a segment connecting the critical points is within a given value. If the critical points are determined to be connectible, the resulting segment between the critical points can be assigned a weight based on the length of the segment. In one aspect, this can be done using, for example, a Euclidean distance of the segment.

### Example Method III

FIG. 7 illustrates an example process 700 for determining a motherbore in accordance with one implementation of well placement in a volume.

At block 702, once a skeleton for a volume is isolated, the skeleton is viewed for the existence of multiple branches. In some cases, there will be only one branch and the single branch will be seen as the motherbore.

In other cases, the skeleton will include two or more branches, such as for example, branches 306, 308 and 310. In such a case a branch having a favorable curvature can be seen as a motherbore, while other branches can be seen as being laterals from the motherbore. In one implementation a favorable curvature will be a curvature below a preset value.

At block 704 if several branches have a similar curvature, other qualities such as length can be used to determine the motherbore (for example, with the longest branch being seen as the motherbore).

At block 706 branches that have not been designated as the motherbore are designated as laterals to the mother bore. For example, branches in block 702 not being designated as the motherbore are designated as laterals. Similarly, branches shorter in length than the motherbore found at block 704 are determined to be laterals;

### CONCLUSION

Although embodiments of well placement in a volume have been described in language specific to structural features and/or methods, it is to be understood that the subject of the appended claims is not necessarily limited to the specific features or methods described. Rather, the specific features and methods are disclosed as exemplary implementations of well placement in a volume.

What is claimed is:

1. A method comprising:
obtaining a volume within a reservoir, the volume being defined by a boundary;
determining a skeleton for the volume; and
ascertaining a well topology for the volume based on the skeleton.

2. The method of claim 1, wherein obtaining includes creating the volume by selecting one or more cells in a reservoir model associated with a given geological property.

3. The method of claim 2, wherein selecting includes locating one ore more cells in the reservoir model having an oil saturation percentage exceeding a preset oil saturation percentage.

4. The method of claim 1, wherein determining includes identifying one or more critical points within the volume.

5. The method of claim 4, wherein identifying includes:
assigning the boundary of the volume a first potential decreasing with distance from the boundary; and
locating the one or more critical points as points within the three dimensional space which are subjected to a preset range of resulting potential.

6. The method of claim 5, further comprising:
perturbing the volume by assigning a geographic feature associated with the volume a second potential decreasing with distance from the geographic feature.

7. The method of claim 1, wherein determining includes:
defining the skeleton to be a volumetric centroid of the volume.

8. The method of claim 1, wherein ascertaining includes:
identifying a mother bore defined by a line of critical points having a curvature less than a predetermined value.

9. The method of claim 8, further comprising identifying a lateral bore defined by a line of critical points having a curvature grater than the predetermined value.

10. A computer-readable medium having a set of computer-readable instructions residing thereon that, when executed, perform acts comprising:
accessing data representing a volume within a reservoir, the volume being defined by a boundary;
calculating a skeleton for the volume; and
plotting placement of a well configured to allow access to resources in the volume, the placement being based on the skeleton.

11. The computer-readable medium of claim 10 having a set of computer-readable instructions that, when executed, perform acts further comprising calculating the skeleton based on segments connecting adjacent critical points within the volume.

12. The computer-readable medium of claim 10 having a set of computer-readable instructions that, when executed, perform acts further comprising:
generating a potential field over the volume by assigning the boundary a given potential with the potential decreasing with distance from the boundary; and
identifying critical points within the volume as points where a sum of potential is below a preset value;
determining a skeleton for the volume based on the critical points.

13. The computer-readable medium of claim 10 having a set of computer-readable instructions that, when executed, perform acts further comprising:
perturbing the potential field based on one or more properties of the reservoir.

14. The computer-readable medium of claim 10 having a set of computer-readable instructions that, when executed, perform acts further comprising plotting a placement of a mother bore and at least one lateral based on the skeleton, wherein the mother bore has a curvature below a preset value.

15. The computer-readable medium of claim 10 having a set of computer-readable instructions that, when executed, perform acts further comprising examining the plotting placement through use of a well design algorithm to create a well drilling plan.

16. A method comprising:
generating a potential field throughout a model of a volume within a reservoir, wherein the potential field has a maximum potential value at a boundary enclosing the volume, the potential value declining with distance from the boundary;
examining the potential field throughout the volume to identify critical points having a potential within a preset range;
determining a skeleton of the volume based on the critical points; and
ascertaining a well topology based on the skeleton.

17. The method of claim 16, wherein generating further includes perturbing the potential field throughout the model based on one or more geographic features associated with the volume.

18. The method of claim 16, wherein examining further includes identifying critical points having a potential of zero.

19. The method of claim 16, wherein determining further includes constructing the skeleton from critical points using a spanning tree algorithm.

20. The method of claim 16, further comprising processing the well topology using a computer implemented well design algorithm.
